(19) United States
(12) Patent Application Publication
(10) Pub. No.: US 2025/0321761 A1
(43) Pub. Date: Oct. 16, 2025

(54) MULTIMEDIA INTEGRATION SYSTEM AND A MULTIMEDIA INTEGRATION METHOD

(71) Applicant: OPTOMA CORPORATION, NEW TAIPEI CITY (TW)

(72) Inventors: Tung-Ping Lee, NEW TAIPEI CITY (TW); Kai-Ming Guo, NEW TAIPEI CITY (TW); Ching-Hung Chen, NEW TAIPEI CITY (TW); Chia-Hui Tai, NEW TAIPEI CITY (TW)

(21) Appl. No.: 19/071,813

(22) Filed: Mar. 6, 2025

(30) Foreign Application Priority Data
Apr. 11, 2024 (TW) 113113541

(51) Int. Cl. G06F 9/451; G06F 3/04842

(52) U.S. Cl. CPC G06F 9/451; G06F 3/04842

(57) ABSTRACT

The disclosure is related to a multimedia integration system and a multimedia integration method. The multimedia integration system includes a display device and a multimedia integration host. The multimedia integration method includes: establishing a communication connection between the display device and the multimedia integration host; executing, by the display device, a multimedia integration software to generate a user interface; selecting at least one target software file through the user interface; displaying, by the display device, a streaming image through the multimedia integration software; and displaying an updated streaming image based on an input control signal generated by the display device.

### CROSS-REFERENCES

This application claims the priority benefit of Taiwan Patent Application Serial Number 113113541, filed on Apr. 11, 2024, the full disclosure of which is incorporated herein by reference.

### TECHNICAL FIELD

The disclosure is related to an electronic system. More particularly, the embodiments are related to a multimedia integration system and a multimedia integration method applied to the multimedia integration system.

### DESCRIPTION OF RELATED ART

In recent years, with the development of digital learning, teachers have widely used various digital resources to enrich the teaching content. Therefore, various teaching software has also emerged accordingly.

When developing a teaching software, in order to be able to coordinate with a variety of different software, the development team needs to adapt to the application programming interface (API) of each software or copy the operating functions of the software to develop the teaching software. As a result, the development cost of teaching software has increased significantly. In addition, since the application programming interface of each software is frequently updated, the development team must update the teaching software according to the updated application programming interface, which also increases the cost and difficulty of the maintenance of the teaching software.

Therefore, existing systems have considerable requirements on the integration of digital resources for the development of teaching software.

The information disclosed in this DESCRIPTION OF RELATED ART section is only for enhancement of understanding of the background of the described technology and therefore it may contain information that does not form the prior art that is already known to a person of ordinary skill in the art. Further, the information disclosed in the DESCRIPTION OF RELATED ART section does not mean that one or more problems to be resolved by one or more embodiments of the disclosure was acknowledged by a person of ordinary skill in the art.

### SUMMARY OF THE INVENTION

The embodiment of the disclosure provides a multimedia integration system and a multimedia integration method for completing the integration of digital resources and the display of multimedia files through a display method of a streaming image of a target software file to allow users to apply multimedia files intuitively and visually.

In order to achieve the above object and other related objects, the disclosure provides a multimedia integration method, which includes: establishing a communication connection between a display device and a multimedia integration host; executing, by the display device, a multimedia integration software to generate a user interface; selecting at least one target software file through the user interface, wherein the at least one target software file is stored in the multimedia integration host; displaying, by the display device, a streaming image through the multimedia integration software, wherein the streaming image comprises at least one target image of the at least one target software file; and displaying an updated streaming image based on an input control signal generated by the display device.

In one embodiment, the multimedia integration method further includes: selecting a plurality of target software files through the user interface, and displaying, by the display device, the streaming image through the multimedia integration software, wherein the streaming image comprises a plurality of target images of the plurality of target software files displayed side by side.

In one embodiment, the step of “executing, by the display device, the multimedia integration software to generate the user interface” further includes: executing, by the display device, the multimedia integration software and establishing the communication connection between the display device and the multimedia integration host; executing, by the display device, the multimedia integration software to generate the user interface, wherein the user interface comprises at least one target software file information provided by the multimedia integration host, and the at least one target software file information comprises a name of a target software and at least one file name of the at least one target software file; displaying the user interface through the multimedia integration software of the display device,.

In one embodiment, the step of “displaying, by the display device, the streaming image through the multimedia integration software, wherein the streaming image comprises at least one target image of the at least one target software file” further includes: opening, by the multimedia integration host, the selected at least one target software file; capturing, by the multimedia integration host, at least one displayed window image of the at least one target software file to generate the at least one target image; generating, by the multimedia integration host, the streaming image based on the at least one target image; transmitting, by the multimedia integration host, the streaming image to the display device; executing, by the display device, the multimedia integration software to display the streaming image in an image display area of the user interface.

In one embodiment, the step of “opening, by the multimedia integration host, the selected at least one target software file” includes: transmitting, by the display device, a request signal to the multimedia integration host based on the selected at least one target software file; opening, by the multimedia integration host, the selected at least one target software file based on the request signal.

In one embodiment, the step of “displaying the updated streaming image based on the input control signal generated by the display device” includes: transmitting, by the display device, an input control signal information to the multimedia integration host, wherein the input control signal is generated by an operation of a user and the display device generates the input control signal information corresponding to the input control signal based on the input control signal; obtaining, by the multimedia integration host, a target software file control signal based on a display ratio information and the input control signal information; triggering, by the multimedia integration host, an operation event of the at least one target software file to update the at least one displayed window image of the at least one target software file based on the target software file control signal; capturing, by the multimedia integration host, the at least one displayed window image of the at least one target software file to generate the updated at least one target image; generating, by the multimedia integration host, the streaming image based on the at least one target image; transmitting, by the multimedia integration host, the streaming image to the display device; displaying, by the display device, the updated streaming image.

In one embodiment, the display ratio information indicates a conversion ratio between the image display area of the user interface and the at least one displayed window image.

In one embodiment, the target software file control signal includes an absolute coordinate information corresponding to the at least one displayed window image and an operation information.

In order to achieve the above object and other related objects, the disclosure provides a multimedia integration system, which includes a display device and a multimedia integration host. The multimedia integration host is communicatively connected to the display device. The multimedia integration host stores at least one target software file. The display device executes a multimedia integration software to generate a user interface. The user interface of the display device is used for selecting the at least one target software file. The display device executes the multimedia integration software to display a streaming image. The streaming image includes at least one target image of the at least one target software file. The display device displays an updated streaming image based on the input control signal generated by the display device.

In one embodiment, the user interface of the display device is used for selecting a plurality of target software files. The display device executes the multimedia integration software to display the streaming image, wherein the streaming image includes a plurality of target images of the plurality of target software files displayed side by side.

In one embodiment, the multimedia integration host provides at least one target software file information. The display device executes the multimedia integration software to generate the user interface, wherein the at least one target software file information comprises a name of a target software and at least one file name of the at least one target software file.

In one embodiment, the multimedia integration host opens the selected at least one target software file, captures at least one displayed window image of the at least one target software file to generate the at least one target image, and generates the streaming image based on the at least one target image.

In one embodiment, the display device executes the multimedia integration software to display the streaming image in an image display area of the user interface.

In one embodiment, the multimedia integration host obtains a target software file control signal based on a display ratio information and an input control signal information. The multimedia integration host triggers an operation event of the at least one target software file based on the target software file control signal to update at least one displayed window image of the at least one target software file. The multimedia integration host captures the at least one displayed window image of the at least one target software file to generate the updated at least one target image.

In one embodiment, the display ratio information indicates a conversion ratio between the image display area of the user interface and the displayed window image.

In one embodiment, the target software file control signal includes an absolute coordinate information corresponding to the at least one displayed window image and an operation information.

In one embodiment, an operating system of the display device is different from an operating system of the multimedia integration host.

In one embodiment, the multimedia integration host is electrically connected to a monitor, and the monitor displays at least one displayed window image of the at least one target software file.

According to the above, the multimedia integration system and the multimedia integration method executed by the multimedia integration software of the disclosure integrate the target software file through the display of the streaming image of the target software file. The multimedia integration software does not need to integrate target software files through application programming interfaces or replicating software operating functions. The purpose of integrating digital resources and displaying multimedia files is achieved.

Other objectives, features and advantages of the disclosure will be further understood from the further technological features disclosed by the embodiments of the disclosure, wherein there are shown and described preferred embodiments of this invention simply by way of illustration of modes best suited to carry out the invention.

### BRIEF DESCRIPTION OF DRAWINGS

FIG. 1 is a schematic of a multimedia integration system according to an embodiment of the disclosure.

FIG. 2 is a schematic of a display device according to an embodiment of the disclosure.

FIG. 3 is a first schematic of a user interface according to an embodiment of the disclosure.

FIG. 4 is a second schematic of a user interface according to an embodiment of the disclosure.

FIG. 5 is a schematic of a multimedia integration host according to an embodiment of the disclosure.

FIG. 6 is a first schematic of a flow chart of a multimedia integration method according to an embodiment of the disclosure.

FIG. 7 is a second schematic of a flow chart of a multimedia integration method according to an embodiment of the disclosure.

FIG. 8 is a third schematic of a flow chart of a multimedia integration method according to an embodiment of the disclosure.

FIG. 9 is a fourth schematic of a flow chart of a multimedia integration method according to an embodiment of the disclosure.

### DESCRIPTION OF THE INVENTION

It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein, are used broadly and encompass direct and indirect connections, couplings, and mountings.

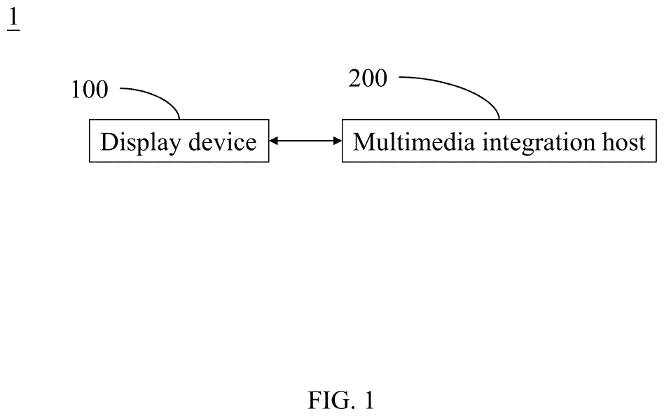

FIG. 1 is a schematic of a multimedia integration system according to an embodiment of the disclosure. The multimedia integration system 1 includes a display device 100 and a multimedia integration host 200. The display device 100 and the multimedia integration host 200 establish a communication connection through a network. The display device 100 and the multimedia integration host 200 are communicatively connected and receive signals from each other. The network is, for example, a wired network or a wireless network, and the disclosure is not limited thereto, and detailed description of the network is not relevant to the disclosure.

In one embodiment, the display device 100 and the multimedia integration host 200 are connected through a physical line. The physical line is, for example, an HDMI cable or a USB cable, and the physical line is not described in detail.

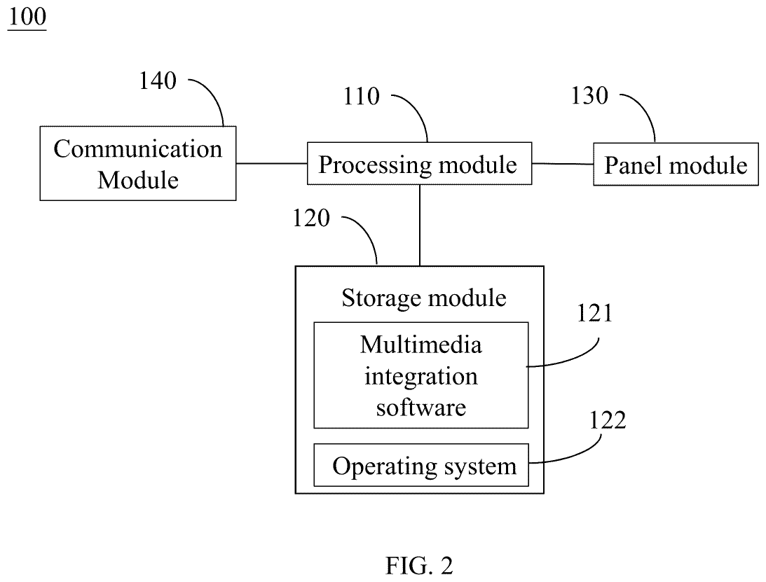

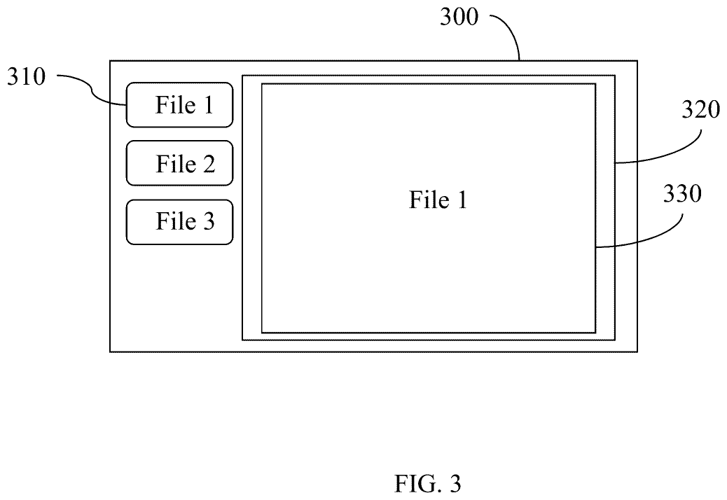

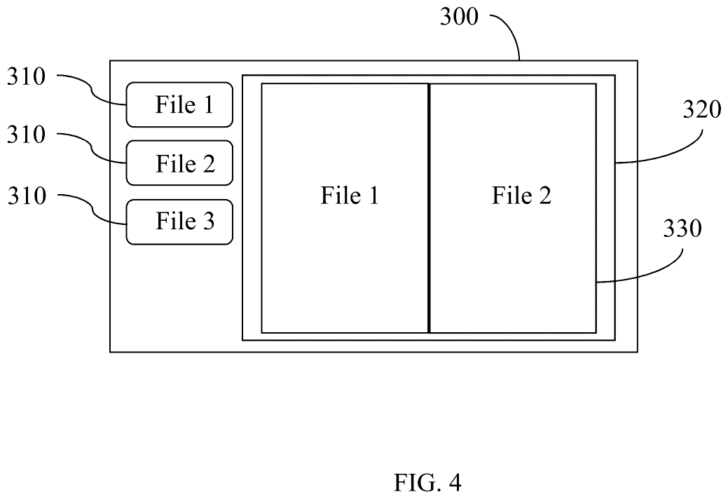

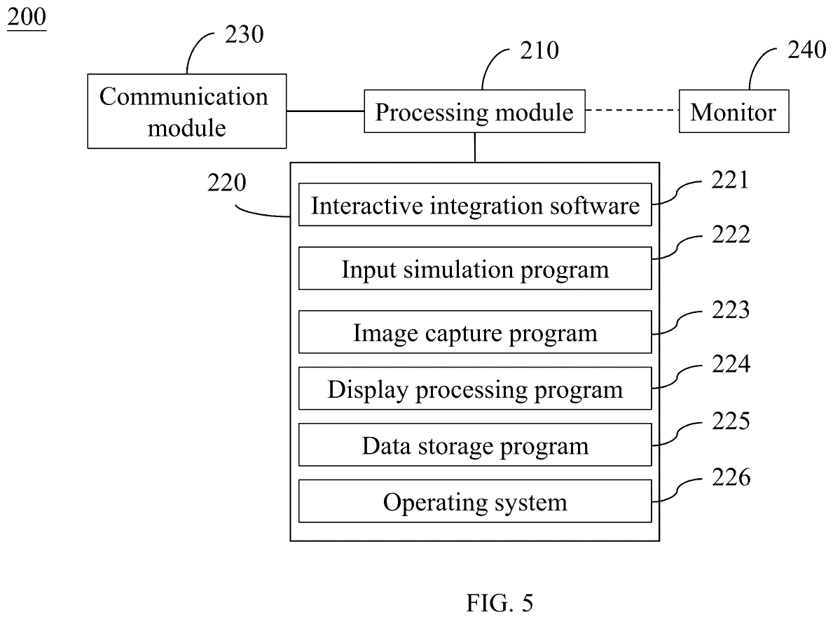

Please refer to FIG. 2, FIG. 3, FIG. 4 and FIG. 5. FIG. 2 is a schematic of a display device according to an embodiment of the disclosure. FIG. 3 is a first schematic of a user interface according to an embodiment of the disclosure. FIG. 4 is a second schematic of a user interface according to an embodiment of the disclosure. FIG. 5 is a schematic of a multimedia integration host according to an embodiment of the disclosure.

In the embodiment of FIG. 2, the display device 100 includes a processing module 110, a storage module 120, a panel module 130 and a communication module 140. The processing module 110 is electrically connected to the storage module 120, the panel module 130 and the communication module 140. An electrical connection is defined as a connection that may transmit electrical signals. The processing module 110 may access or read the programs, software and operating system stored in the storage module 120.

In one embodiment, the processing module 110 may include at least one processor. The processor is, for example, a central processing unit (CPU), a microprocessor, a microcontroller or other similar components or combinations of the above components, and the disclosure is not limited thereto.

The storage module 120 stores a multimedia integration software 121 and an operating system 122. The multimedia integration software 121 is read and executed by the processing module 110. The operating system 122 is read and executed by the processing module 110.

In one embodiment, the storage module 120 is, for example, at least one memory. A memory comprises, for example, random-access memory (RAM), read-only memory (ROM), flash memory, a hard disk drive (HDD), and/or a solid-state drive (SSD), and the disclosure is not limited thereto.

The panel module 130 displays the user interface 300 and a streaming image. The panel module 130 is, for example, a liquid crystal panel (LC panel), a light-emitting diode (LED) monitor, or an organic light-emitting diode (OLED) monitor. In addition, a touch panel may be disposed above the panel module 130 for receiving operations of the user, and the disclosure is not limited thereto.

The communication module 140 establishes the communication connection with the multimedia integration host 200. In one embodiment, the communication module 140 is, for example, a communication circuit or chip that complies with the Ethernet standard, the Wireless LAN standard, or the Global System for Mobile Communication (GSM) standard.

In one embodiment, the communication module 140 of the display device 100 is, for example, an HDMI interface circuit or a USB interface circuit.

In one embodiment, the display device 100 is, for example, an interactive flat panel (IFP), a smart phone or a smart tablet, and the disclosure is not limited thereto.

In the embodiment of FIG. 2, the user may operate the display device 100 through the touch panel to establish a communication connection between the display device 100 and the multimedia integration host 200. For example, the display device 100 establishes the communication connection with the multimedia integration host 200 through a network cable or wireless network. After the communication connection is established between the display device 100 and the multimedia integration host 200, the user operates the display device 100 to execute the multimedia integration software 121. The processing module 110 reads and executes the multimedia integration software 121 of the storage module 120 in response to the user's operation.

Further, the processing module 110 executes the multimedia integration software 121. The processing module 110 generates a startup notification message and transmits the startup notification message to the multimedia integration host 200 through the communication module 140. The startup notification message is used to notify the multimedia integration host 200 that the display device 100 has executed the multimedia integration software 121.

Please refer to FIG. 3 and FIG. 4. The multimedia integration host 200 provides a target software file information to the display device 100 according to the startup notification message. After the processing module 110 of the display device 100 receives the target software file information from the multimedia integration host 200, the processing module 110 executes the multimedia integration software 121 based on the target software file information to generate the user interface 300 and causes the panel module 130 to display the user interface 300. The user interface 300 includes the target software file information (such as the symbol 310 in FIG. 3 or FIG. 4). The target software file information is, for example, the name of the target software and the file name of the target software file, and the disclosure is not limited thereto. In one embodiment, the target software is, for example, Word, PowerPoint (PPT), Excel or other software. The target software file is, for example, a presentation file, a document file, an image file, a video file, etc., and the disclosure is not limited thereto.

Further, the processing module 110 determines that a target software file information displayed by the user interface 300 is selected based on the input control signal. For example, when the user interface 300 displays at least one target software, the user may operate the display device 100 and select a target software file information displayed by the user interface 300 (for example, “File 1” in FIG. 3). The processing module 110 generates the input control signals corresponding to the operation of user. The input control signal indicates the operation performed by the user and the location where the operation event occurs in the user interface 300. In one embodiment, the input control signal may include a coordinate information of a cursor position and an operation information (actions such as dragging, clicking, etc.).

Further, the processing module 110 generates a request signal based on the selected target software file information, and the processing module 110 transmits the request signal to the multimedia integration host 200 through the communication module 140.

Further, the multimedia integration host 200 provides the streaming image to the display device 100 according to the request signal. The processing module 110 of the display device 100 receives the streaming image from the multimedia integration host 200 through the communication module 140. The processing module 110 executes the multimedia integration software 121 and provides the streaming image to the panel module 130 to form a display image 330. It means that contents of the display image 330 comprise contents of the streaming image. The display image 330 is displayed in the image display area 320 of the user interface 300. The display range of the user interface 300 is greater than the display range of the image display area 320, and the image display area 320 is greater than the display image 330. The streaming image is the display image 330 displayed in the image display area 320, and the streaming image is a target image generated after the target software file is opened. The so-called streaming image is a single image in the target software file. The display device 100 does not need to download the target software file of the multimedia integration host 200 to the display device 100. Therefore, the display device 100 does not need to store the target software file. In addition, the streaming image is the updated target image generated after the user operates the target software file through the display device 100. The streaming image includes one or more target images. When the streaming image includes a plurality of target images of a first target software file (file 1) and a second target software file (file 2), the target images are arranged side by side in one streaming image (as shown in FIG. 4). The display positions of the target images may be adjusted according to the operation the user.

In one embodiment, the file formats of the plurality of target images may be the same or different. For example, the file formats of the plurality of target images may be a document file format. For example, the file format of the plurality of target images may be a document file format and an image file format. The disclosure is not limited thereto.

Further, the processing module 110 determines the user's control operation corresponding to the streaming image of the target software file based on the input control signal. For example, the processing module 110 determines based on the coordinate information of the input control signal that the user performs operations such as dragging and clicking corresponding to the display image 330 of the image display area 320. The processing module 110 generates input control signal information corresponding to the input control signal based on the input control signal generated by the user's operation, and the processing module 110 transmits the input control signal information to the multimedia integration host 200 through the communication module 140. The input control signal information includes the coordinate information and the operation information of the user's operation content. Thereby, the processing module 110 may provide the user's control operation corresponding to the streaming image to the multimedia integration host 200 to receive the updated target image generated corresponding to the user's control operation.

Therefore, in the embodiment of FIG. 2, the display device 100 does not need to store the target software file. The display device 100 only needs to execute the multimedia integration software 121, and the user may operate the target software file 310 through the user interface 300 of the multimedia integration software 121. Therefore, the hardware requirements of the display device 100 are effectively reduced. In the embodiment of the streaming image having the plurality of target images, since the target images are integrated into the same streaming image and the target images are integrated into a single object, the display device 100 may display the target images at the same time. The user may operate the target images separately through the display device 100. In other words, the display device 100 may display the plurality of target software files (for example, the first target software file and the second target software file) at the same time, and the user may operate the target software files through the display device 100 respectively. Compared with the method of displaying a single target software file at the same time, the disclosure more effectively improves the convenience for users to operate a plurality of target software files.

FIG. 5 is a schematic of the multimedia integration host 200 according to an embodiment of the disclosure. The multimedia integration host 200 includes a processing module 210, a storage module 220, a communication module 230 and a monitor 240. The processing module 210, the storage module 220 and the communication module 230 have the same hardware as the above-mentioned processing module 110, the storage module 120 and the communication module 140. The monitor 240 has the same hardware as the above-mentioned panel module 130.

In the embodiment of FIG. 5, the processing module 210 is electrically connected to the storage module 220, the communication module 230 and the monitor 240 respectively. The processing module 210 reads the programs, software and operating systems stored in the storage module 220 to execute the multimedia integration host 200 and the multimedia integration method.

In the embodiment of FIG. 5, the storage module 220 stores an interactive integration software 221, an input simulation program 222, an image capture program 223, a display processing program 224, a data storage program 225 and an operating system 226. The interactive integration software 221, the input simulation program 222, the image capture program 223 and the display processing program 224 are read and executed by the processing module 210. The operating system 226 is read and executed by the processing module 210. The data storage program 225 stores one or more target software files and one or more target software.

In one embodiment, the operating system of the multimedia integration host 200 and the operating system of the display device 100 may be the same or different. For example, the operating system of the multimedia integration host 200 may be Microsoft's Windows operating system, and the operating system of the display device 100 may be a mobile operating system (an Android operating system or iOS), and the disclosure is not limited thereto.

In the embodiment of FIG. 5, the monitor 240 displays a desktop image and the displayed window image. The desktop is generated by the multimedia integration host 200 when the multimedia integration host 200 executes the operating system. The displayed window image is generated by the multimedia integration host 200 after the multimedia integration host 200 executes the target software file. In one embodiment, the monitor 240 may be a physical display device, such as a liquid crystal display. The monitor 240 displays the desktop image and the displayed window image generated after executing the target software file. In another embodiment, the monitor 240 may be a virtual display, such as a virtual display implemented by virtual display software, which is not visible to the user.

In one embodiment, the multimedia integration host 200 is, for example, a cloud server host or a desktop host (desktop computer), and the disclosure is not limited thereto.

In the embodiment of FIG. 5, the interactive integration software 221 executed by the processing module 210 and the multimedia integration software 121 executed by the display device 100 establish a communication connection. The processing module 210 executes the interactive integration software 221 to perform the following operations. When the processing module 210 receives the startup notification message from the display device 100, the processing module 210 reads the target software file information of all target software files stored in the storage module 220 based on the startup notification message. The processing module 210 transmits the target software file information to the communication module 140 of the display device 100 through the communication module 230. When the processing module 210 receives the request signal from the display device 100, the processing module 210 opens the target software file corresponding to the request signal in the operating system of the multimedia integration host 200 based on the request signal. The processing module 210 converts the target image of the target software file into the streaming image and transmits the streaming image to the display device 100 in real-time by a streaming manner. The so-called streaming manner is that a signal of a single frame of the target software file is transmitted to the display device 100 segment by segment in real-time. Therefore, the entire target software file does not need to be downloaded to the display device 100. It may achieve reductions of the transmission time of network.

In the embodiment of FIG. 5, the processing module 210 executes the input simulation program 222 to perform the following operations. When the processing module 210 receives the input control signal information from the display device 100, the processing module 210 converts the input control signal information based on the display ratio information to obtain the target software file control signal. The input control signal information includes the coordinate information and the operation information. After receiving the input control signal information, the processing module 210 obtains the coordinate information of the input control signal information. The processing module 210 converts the coordinate information into an absolute coordinate information based on the display ratio information. The processing module 210 generates the target software file control signal based on the absolute coordinate information and the operation information of the input control signal information.

In one embodiment, the display ratio information is the ratio of the resolution of the displayed window image of the target software file to the resolution of the image display area 320 of the user interface 300 of the display device 100. The resolution of the image display area 320 of the user interface 300 of the display device 100 is transmitted to the processing module 210 by the display device 100. In this embodiment, the resolution of the display image 330 is the same as the resolution of the image display area 320. That is, the display ratio information indicates the conversion ratio between the image display area 320 and the displayed window image. The resolution of the displayed window image of the target software file refers to the resolution to be displayed on the monitor 240 or virtual monitor when the target software file is opened. In one embodiment, the resolution of the displayed window image of the target software file is only a signal information and is not for displaying.

In one embodiment, the display ratio information is the ratio of the resolution of the displayed window image of the target software file to the resolution of the displayed image 330 of the user interface 300 of the display device 100. In this embodiment, the resolution of the display image 330 is different from the resolution of the image display area 320.

In this embodiment, the processing module 210 triggers the operation event of the target software file based on the target software file control signal to update the displayed window image of the target software file. Such operation events are, for example, moving the displayed window image, selecting objects, etc., and the disclosure is not limited thereto. The processing module 210 may proportionally convert the coordinate information from the display device 100 into the absolute coordinate information corresponding to the displayed window image of the target software file. The processing module 210 causes the target software file to execute the corresponding operation event based on the absolute coordinate information and the operation information (input control signal information). Therefore, the displayed window image of the target software file is updated and thus is the updated target image. For example: based on the absolute coordinate information and the operation information, the cursor in the displayed window image of the target software file moves to the object indicated as “next page”.

In the embodiment of FIG. 5, the processing module 210 executes the image capture program 223 to perform the following operations. The processing module 210 captures the displayed window image of the target software file to generate the target image. Further, when the target software file is opened or the displayed window image is updated, the processing module 210 captures the displayed window image of the target software file to generate an updated target image. In one embodiment, when a plurality of target software files are open and the displayed window image of one of the plurality of target software files is updated, the processing module 210 individually captures each of the displayed window images of the plurality of target software files to generate the plurality of target images.

In the embodiment of FIG. 5, the processing module 210 executes the display processing program 224 to perform the following operations. The display processing program 224 executed by the processing module 210 performs image processing on the target image, and the target image is converted into a streaming image through the interactive integration software 221. The streaming image includes a single target image. In another embodiment, when a plurality of target software files are opened, the display processing program 224 executed by the processing module 210 performs image processing on the plurality of target images of the plurality of target software files, integrates the plurality of target images into a single integrated target image, and causes the integrated target image to be converted into a streaming image through the interactive integration software 221. In this embodiment, the streaming image includes the plurality of target images, and the plurality of target images are displayed side by side (as shown in FIG. 4).

Therefore, in the embodiment of FIG. 5, the multimedia integration host 200 may execute the target software file, generate the streaming image of the target software file, and provide the streaming image to the display device 100. In this way, the multimedia integration software 121 executed by the display device 100 does not need to integrate the target software files through an application programming interface or copy the operating functions of the software to achieve the purpose of integrating digital resources and displaying multimedia files.

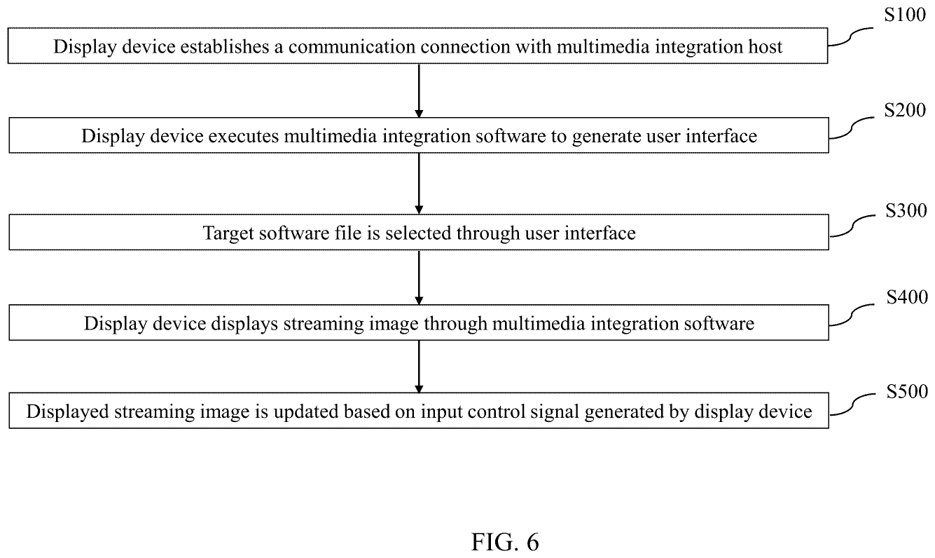

Based on the above, the disclosure may further include the multimedia integration method as shown in FIG. 6 to FIG. 9. The multimedia integration method may be applied to the multimedia integration system 1 shown in FIG. 1.

Please refer to FIG. 6. FIG. 6 is a first schematic of a flow chart of a multimedia integration method according to an embodiment of the disclosure. FIG. 6 includes steps S100 to S500.

In step S100, the display device 100 establishes a communication connection with the multimedia integration host 200. In step S200, the display device 100 executes the multimedia integration software 121 to generate the user interface 300. In step S300, the target software file is selected through the user interface 300. In this step, the processing module 110 of the display device 100 determines that a piece of target software file information displayed by the user interface 300 is selected based on the input control signal. In step S400, the display device 100 displays the streaming image through the multimedia integration software 121. The streaming image includes the target image of the target software file. In step S500, the displayed streaming image is updated based on the input control signal generated by the display device 100.

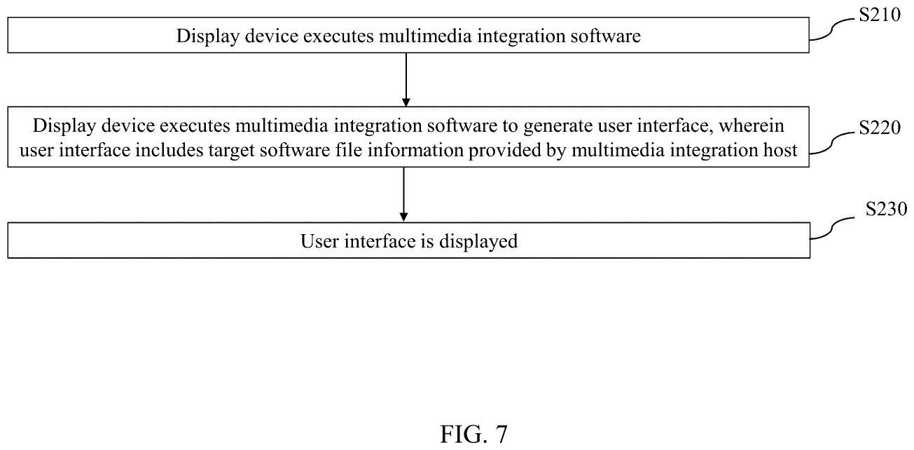

Please refer to FIG. 2 and FIG. 7. FIG. 7 is a second schematic of a flow chart of a multimedia integration method according to an embodiment of the disclosure. FIG. 7 includes steps S210 to S230.

In step S210, the display device 100 executes the multimedia integration software 121. In this embodiment, the user operates the display device 100 to execute the multimedia integration software 121. The processing module 110 of the display device 100 reads and executes the multimedia integration software 121 of the storage module 120. After the processing module 110 executes the multimedia integration software 121, the processing module 110 generates a startup notification message and transmits the startup notification message to the multimedia integration host 200 through the communication module 140 to receive the target software file information from the multimedia integration host 200.

In step S220, the display device 100 executes the multimedia integration software 121 to generate the user interface 300, wherein the user interface 300 includes the target software file information provided by the multimedia integration host 200. In this step, after the processing module 110 receives the target software file information from the multimedia integration host 200, the multimedia integration software 121 executed by the processing module 110 generates the user interface 300. The user interface 300 includes the target software file information provided by the multimedia integration host 200. The target software file information includes, for example, the name of the target software and the file name of the target software file.

In step S230, the user interface 300 is displayed. In this step, the processing module 110 causes the panel module 130 to display the user interface 300.

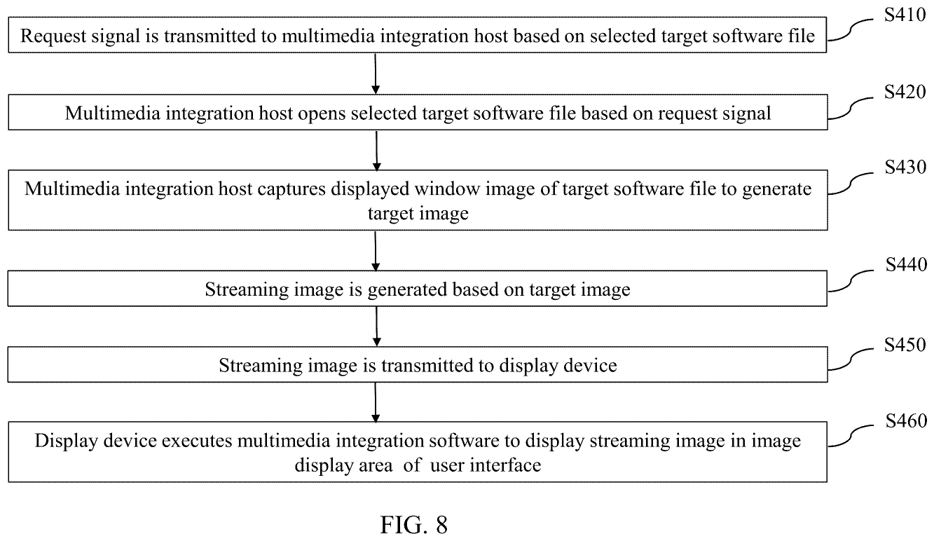

Please refer to FIGS. 2 to 5 and FIG. 8. FIG. 8 is a third schematic of a flow chart of a multimedia integration method according to an embodiment of the disclosure. FIG. 8 includes steps S410 to S460.

In step S410, the request signal is transmitted to the multimedia integration host 200 based on the selected target software file. In this step, the processing module 110 of the display device 100 determines that a target software file information displayed by the user interface 300 is selected based on the input control signal. The processing module 110 generates the request signal and transmits the request signal to the multimedia integration host 200 through the communication module 140.

In step S420, the multimedia integration host 200 opens the selected target software file based on the request signal. In this step, when the processing module 210 of the multimedia integration host 200 receives the request signal from the display device 100, the processing module 210 executes the operating system 226 based on the request signal and opens the target software file corresponding to the request signal in the operating system of the multimedia integration host 200.

In step S430, the multimedia integration host 200 captures the displayed window image of the target software file to generate the target image. In this step, the processing module 210 of the multimedia integration host 200 captures the displayed window image of the target software file to generate the target image.

In step S440, the streaming image is generated based on the target image. In this step, the processing module 210 of the multimedia integration host 200 converts the target image into the streaming image.

In step S450, the streaming image is transmitted to the display device 100. In this step, the processing module 210 of the multimedia integration host 200 transmits the streaming image to the display device 100 through the communication module 230.

In step S460, the display device 100 executes the multimedia integration software 121 to display the streaming image in the image display area 320 of the user interface 300. In this step, the processing module 110 of the display device 100 executes the multimedia integration software 121 to provide the streaming image to the panel module 130 to form the display image 330. The display image 330 is displayed in the image display area 320 of the user interface 300. The streaming image, that is, the display image 330, is displayed in the image display area 320.

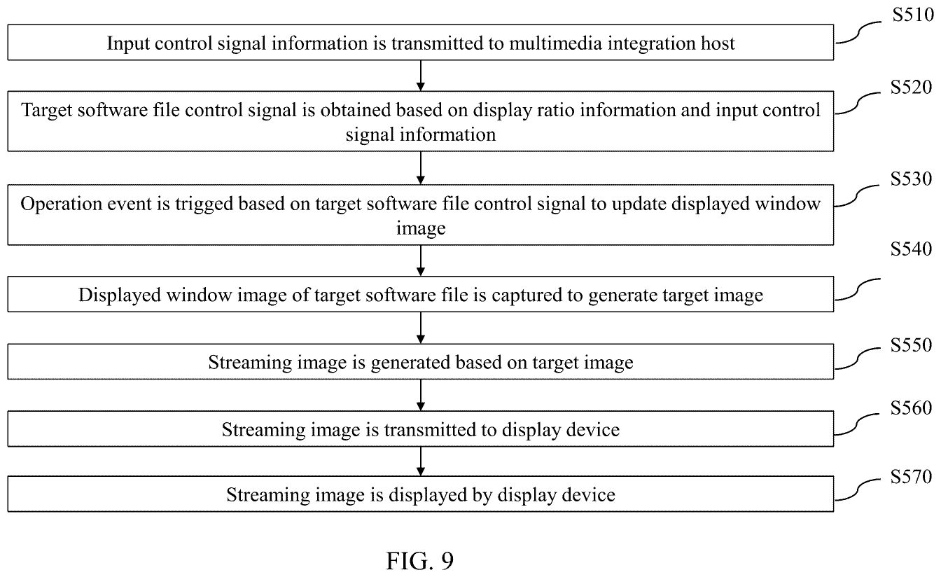

Please refer to FIG. 2 to FIG. 5 and FIG. 9. FIG. 9 is a fourth schematic of a flow chart of a multimedia integration method according to an embodiment of the disclosure. FIG. 9 includes steps S510 to S570.

In step S510, the input control signal information is transmitted to the multimedia integration host 200. In this step, the processing module 110 of the display device 100 generates the input control signal information based on the input control signal generated by the user's operation and transmits the input control signal information to the multimedia integration host 200 through the communication module 140.

In step S520, the target software file control signal is obtained based on the display ratio information and the input control signal information. In this step, when the processing module 210 of the multimedia integration host 200 receives the input control signal information, the processing module 210 obtains the coordinate information from the input control signal information. The processing module 210 converts the coordinate information into the absolute coordinate information based on the display ratio information. The processing module 210 generates the target software file control signal based on the operation information of the absolute coordinate information and the input control signal information.

In step S530, the operation event is triggered based on the target software file control signal to update the displayed window image. In this step, the processing module 210 causes the target software file to execute the corresponding operation event based on the absolute coordinate information and the operation information to update the displayed window image of the target software file (that is, to update the target image).

In step S540, the displayed window image of the target software file is captured to generate the target image. In this step, the processing module 210 of the multimedia integration host 200 captures the updated displayed window image to generate the target image.

In step S550, the streaming image is generated based on the target image. In this step, the processing module 210 of the multimedia integration host 200 executes the interactive integration software 221 to convert the target image into the streaming image.

In step S560, the streaming image is transmitted to the display device 100.

In step S570, the streaming image is displayed by the display device 100.

According to the above, the multimedia integration system and multimedia integration method of the application execute multimedia integration software to display the streaming image of the target software file such that the multimedia integration system does not need to perform the integration between target software files through an application programming interface or copy the operating functions of the software to achieve the purpose of integrating digital resources and displaying multimedia files. At the same time, users may operate the plurality of target software files through the display device. The display device may simultaneously display the plurality of target images corresponding to the plurality of target software files, allowing users to operate the plurality of target images separately, which effectively improves the user's convenience in operating multiple target software files.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode of practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

1. A multimedia integration method, comprising:
establishing a communication connection between a display device and a multimedia integration host;
executing, by the display device, a multimedia integration software to generate a user interface;
selecting at least one target software file through the user interface, wherein the at least one target software file is stored in the multimedia integration host;
displaying, by the display device, a streaming image through the multimedia integration software, wherein the streaming image comprises at least one target image of the at least one target software file; and
displaying an updated streaming image based on an input control signal generated by the display device.

2. The multimedia integration method as claimed in claim 1, further comprising:
selecting a plurality of target software files through the user interface; and
displaying, by the display device, the streaming image through the multimedia integration software, wherein the streaming image comprises a plurality of target images of the plurality of target software files displayed side by side.

3. The multimedia integration method as claimed in claim 1, wherein the step of “executing, by the display device, the multimedia integration software to generate the user interface” further comprises:
executing, by the display device, the multimedia integration software and establishing the communication connection between the display device and the multimedia integration host;
executing, by the display device, the multimedia integration software to generate the user interface, wherein the user interface comprises at least one target software file information provided by the multimedia integration host, and the at least one target software file information comprises a name of a target software and at least one file name of the at least one target software file; and
displaying the user interface through the multimedia integration software of the display device.

4. The multimedia integration method as claimed in claim 1, wherein the step of “displaying, by the display device, the streaming image through the multimedia integration software, wherein the streaming image comprises at least one target image of the at least one target software file” further comprises:
opening, by the multimedia integration host, the selected at least one target software file;
capturing, by the multimedia integration host, at least one displayed window image of the at least one target software file to generate the at least one target image;
generating, by the multimedia integration host, the streaming image based on the at least one target image;
transmitting, by the multimedia integration host, the streaming image to the display device; and
executing, by the display device, the multimedia integration software to display the streaming image in an image display area of the user interface.

5. The multimedia integration method as claimed in claim 4, wherein the step of “opening, by the multimedia integration host, the selected at least one target software file” further comprises:
transmitting, by the display device, a request signal to the multimedia integration host based on the selected at least one target software file; and
opening, by the multimedia integration host, the selected at least one target software file based on the request signal.

6. The multimedia integration method as claimed in claim 4, wherein the step of “displaying the updated streaming image based on the input control signal generated by the display device” further comprises:
transmitting, by the display device, an input control signal information to the multimedia integration host, wherein the input control signal is generated by an operation of a user, and the display device generates the input control signal information based on the input control signal;
obtaining, by the multimedia integration host, a target software file control signal based on a display ratio information and the input control signal information;
triggering, by the multimedia integration host, an operation event of the at least one target software file to update the at least one displayed window image of the at least one target software file based on the target software file control signal;
capturing, by the multimedia integration host, the at least one displayed window image of the at least one target software file to generate the updated at least one target image;
generating, by the multimedia integration host, the streaming image based on the at least one target image;
transmitting, by the multimedia integration host, the streaming image to the display device; and
displaying, by the display device, the updated streaming image.

7. The multimedia integration method as claimed in claim 6, wherein the display ratio information indicates a conversion ratio between the image display area of the user interface and the at least one displayed window image.

8. The multimedia integration method as claimed in claim 6, wherein the target software file control signal comprises an absolute coordinate information corresponding to the at least one displayed window image and an operation information.

9. A multimedia integration system, comprising:
a display device; and
a multimedia integration host, communicatively connected to the display device, and the multimedia integration host configured to store at least one target software file,
wherein the display device is configured to execute a multimedia integration software to generate a user interface, the user interface of the display device is configured to select the at least one target software file, and the display device is configured to execute the multimedia integration software to display a streaming image, wherein the streaming image comprises at least one target image of the at least one target software file, and the display device is configured to display an updated streaming image based on the input control signal generated by the display device.

10. The multimedia integration system as claimed in claim 9, wherein the user interface of the display device is configured to select a plurality of target software files, and the display device is configured to execute the multimedia integration software to display the streaming image, wherein the streaming image comprises a plurality of target images of the plurality of target software files displayed side by side.

11. The multimedia integration system as claimed in claim 9, wherein the multimedia integration host is configured to provide at least one target software file information, and the display device is configured to execute the multimedia integration software to generate the user interface, wherein the at least one target software file information comprises a name of a target software and at least one file name of the at least one target software file.

12. The multimedia integration system as claimed in claim 9, wherein the multimedia integration host is configured to open the selected at least one target software file, capture at least one displayed window image of the at least one target software file to generate the at least one target image, and generate the streaming image based on the at least one target image.

13. The multimedia integration system as claimed in claim 9, wherein the display device is configured to execute the multimedia integration software to display the streaming image in an image display area of the user interface.

14. The multimedia integration system as claimed in claim 13, wherein the multimedia integration host is configured to obtain a target software file control signal based on a display ratio information and an input control signal information, the multimedia integration host is configured to trigger an operation event of the at least one target software file based on the target software file control signal to update at least one displayed window image of the at least one target software file, and the multimedia integration host is configured to capture the at least one displayed window image of the at least one target software file to generate the updated at least one target image.

15. The multimedia integration system as claimed in claim 14, wherein the display ratio information indicates a conversion ratio between the image display area of the user interface and the displayed window image.

16. The multimedia integration system as claimed in claim 14, wherein the target software file control signal comprises an absolute coordinate information corresponding to the at least one displayed window image and an operation information.

17. The multimedia integration system as claimed in claim 9, wherein an operating system of the display device is different from an operating system of the multimedia integration host.

18. The multimedia integration system as claimed in claim 9. wherein the multimedia integration host is electrically connected to a monitor, and the monitor is configured to display at least one displayed window image of the at least one target software file.
